(19) United States
(12) Patent Application Publication
(10) Pub. No.: US 2015/0082203 A1
(43) Pub. Date: Mar. 19, 2015

(54) REAL-TIME ANALYTICS, COLLABORATION, FROM MULTIPLE VIDEO SOURCES

(71) Applicant: TRUESTREAM KK, Shibuya-ku (JP)

(72) Inventors: Paul Daniel James, Florence, MT (US); Arthur Wayne Milliken, Missoula, MT (US); Robert Jack Kinnear, JR., Raleigh, NC (US); Robert Perry Hooker, Bozeman, MT (US)

(73) Assignee: TRUESTREAM KK, Shibuya-ku (JP)

(21) Appl. No.: 14/326,297

(22) Filed: Jul. 8, 2014

Related U.S. Application Data
(60) Provisional application No. 61/843,603, filed on Jul. 8, 2013.

(51) Int. Cl. H04L 29/06; G06F 3/0484

(52) U.S. Cl. CPC H04L 65/60; G06F 3/0484
USPC 715/756

(57) ABSTRACT

A system is engineered to analyze, process, and manipulate streaming content in real time including analyzing, interacting with, and embedding streaming video images based on the content of the images or on collaborative interactions and information. Among many, many examples, one can create advertisements dynamically overlaid within live video based upon characteristics within the live video, as well as have the ability to interact with live video in a social network. Various other examples include, among others, advertising, security analysis, and live special effects. The system performs analytics of data as it is collected to determine features and patterns in the data and use the resulting analysis to alter the streaming content as it occurs.

### CROSS-REFERENCE TO RELATED APPLICATION

This application claims the benefit of U.S. Provisional Application No. 61/843,603, filed Jul. 8, 2013, which is incorporated herein by reference.

### TECHNICAL FIELD

This subject matter is generally related to video processing, and more particularly, it relates to real-time video analytics that facilitates collaboration from multiple sources of video.

### BACKGROUND

Video post-production is part of filmmaking, video production, and photography processes. Video post-production is implemented in the making of motion pictures, television programs, advertising, and so on. Video post-production is a term of art inclusive of all stages of production after the production of a completed video work. Video post-production includes many different processes, such as video editing; adding visual special effects; computer generated imagery; sound effects; and other video enhancement processes. Typically, the post-production phase takes longer than the actual video phase, and can take months to complete. The digital revolution has made video post-processing immeasurably quicker, moving from time-consuming tape editing to online editing, to computer hardware and video editing software, but none of which occurs in real time.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

One aspect of the subject matter includes a system form which recites a system comprising multiple video feeds, the hardware structures of which are suitable for sourcing streaming content. The system also comprises pieces of real-time processing hardware, the hardware structures of which are capable of processing streaming content during a streaming process and not as a post-processing step on stored data. The system further comprises pieces of real-time collaboration hardware, the hardware structures of which have the capacity to facilitate social interactions resulting in modifications to the streaming content.

Another aspect of the subject matter includes a method form which recites a method comprising receiving multiple video feeds in the form of streaming content. The method also comprises real-time processing of streaming content during a streaming process and not as a post-processing step on stored data. The method further comprises facilitating real-time social collaborations resulting in modifications to the streaming content.

A further aspect of the subject matter includes a computer-readable medium form which recites a computer-readable medium, which is non-transitory, having computer-executable instructions stored thereon to implement a method, comprising receiving multiple video feeds in the form of streaming content. The method also comprises real-time processing of streaming content during a streaming process and not as a post-processing step on stored data. The method further comprises facilitating real-time social collaborations resulting in modifications to the streaming content.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an archetypical system with pieces of hardware; and

FIGS. 2A-2O are process diagrams implementing an archetypical method for real-time video processing.

### DETAILED DESCRIPTION

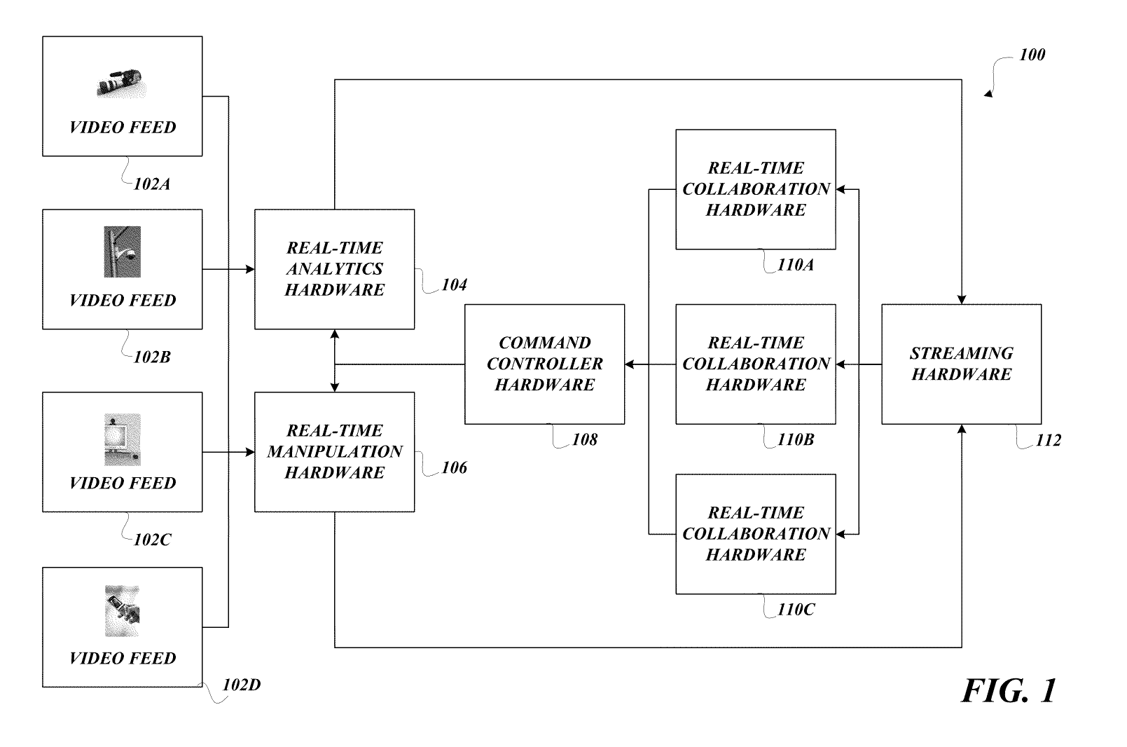

Many embodiments are engineered to analyze, process, and manipulate streaming content in real time. Various embodiments are engineered to analyze, interact with, and embed streaming video images based on the content of the images or on collaborative interactions and information. At FIG. 1, a system 100 is engineered to analyze and manipulate streaming content in real time. The system 100 facilitates dynamic video manipulation in real time based upon information available via analytics calculated from within the streaming content or other alternate data streams. Among many, many examples, one can create advertisements dynamically overlaid within live video based upon characteristics within the live video, as well as the ability to interact with live video in a social network. Various other examples include, among others, advertising, security analysis, and live special effects. The system 100 combines, in real-time video processing, analytics of data as it is collected to determine features and patterns in the data and use the resulting analysis to alter the streaming content as it happens. Thus, one use may embed images or alternate video in a video stream; another use may embed the video stream with chat discussions; or a further use may alter the live streaming content based upon analytics collected about the data of the streaming content.

The term “real-time” or “real time,” as used hereinabove and hereinbelow, means the inclusion of any suitable process that works on the streaming content during the streaming process and not as a post-processing step on stored data. Specifically, the real-time processing of streamed content can occur between, for example, a camera and the video recording device, but does not necessarily apply to post processing the data from the video recording device. This real-time approach is distinct from a near real-time process which introduces a slight buffered delay between the collection of the streamed data and the consumption or recording of that data, and is also distinct from analyses performed shortly after the recording or consumption of the data.

The system 100 includes multiple video feeds 102A-102D, the hardware structures of which are suitable for sourcing streaming content. These video feeds are any continuous streams of data. The streaming content may originate from a variety of sources such as video cameras, audio microphones, digital x-ray machines or magnetic resonance imaging (MRI) machines, seismographs, radar or LIDAR detectors, satellite transmissions, or innumerable other detector or sensor devices as well as mobile communication devices and World Wide Web generated data. The video feeds 102A-102D may occur simultaneously. One example includes a situation in which multiple cameras are following the same scene, each from a different angle.

The system 100 includes pieces of real-time processing hardware. One piece of real-time processing hardware includes real-time analytics hardware 104, the hardware structure of which is capable of performing analytics on data from multiple different types of video feeds 102A-102D to find meaningful patterns from which knowledge about the streaming content is formed. The real-time analytics hardware 104 has the capability to run analytics in the moment of the data, which means at the speed at which the data arrives, and keep it in motion to reduce memory needs. In analysis, the video feeds could be broken up into different analytic categories involving different information not only from each camera, but also from processes about the data coming from the cameras. The real-time analytics hardware 104 has hardware the structure of which performs various analytics functions, including face recognition, object detection, edge detection, background/foreground detection, statistical frequency, color detection, and so on.

Using measurements from the camera metadata in conjunction with calculations of distance, pixels could be represented in a digital elevation model (DEM.) Using the pixels in the video to create a DEM and rectified against dimensions from the camera metadata, the information could be displayed in a continuous three-dimensional (3D) model of the video feed involving no storage to pre-process the data. The end result is a way of visualizing persistent, continuous data to retrieve meaningful knowledge about the streaming content. In embodiments using the information from a video camera, the pixels can be analyzed for elevation data and rendered using a 3D point cloud structure. The data from the video can also be structured across a wire frame to create a subset of the DEM, allowing for further raster to vector calculations. Different features from the camera can be analyzed in-line and in-frame to gain further insight to the data such as the meta-content behind every image and stitched back into the video by maintaining the wireframe and point cloud references.

An example of breaking the video feeds apart into separate inputs includes embodiments to allow the pixels in features such as eyes to become DEM. As the recorded feedback from the database is also constructed so the eyes become DEMs, the embodiments will pattern match the heights by color. While this is going on, the system 100 can use other key point features in the actual image to quickly process other attributes. In a case where security is the issue, all personnel with access to the system can have their facial features recorded. Then, in the case where someone is attempting to conduct an attack using someone else's identity credentials (i.e., driver's license, ID badge, credit card, ATM card, and so on) the security system has the authorized person's image data on file. Attendants or machines can be given proper authority to continue or desist based on the pattern matching results.

Specific embodiments can analyze by the real-time analytics hardware 104 one frame of data against another frame of data continuously. In this case, the frame taken out of video is of an eye. Embodiments can compare different aspects of the eye to ensure it belongs to the authorized personnel. For instance, the video could be turned into a DEM representation of the images where key values in the eye can relate to elevation data instead of just plain color data. The multiple analyses that can be performed on a stream of video at the same time are very different, making the results of the analytics more precise. Embodiments can further break videos into different streams to achieve different analytic results in the same manner. Coupling this with the power to display every stream as it is running allows operators to tune into channels and see the activity concurrent with the video. A use case example would be when a specific embodiment is conducting analytics on video, and something anomalous is detected. While operators cannot manage an extreme amount of video, alerts about which videos are important are sent to operators indicating which channel of video most likely has anomalous activity. The operator can then choose to tune into the channel and monitor the activity, giving yet another dimension of analytics to the overall assessment of the situation.

Another piece of real-time processing hardware includes real-time manipulation hardware 106, the hardware structure of which is suitable to facilitate modification of the streaming content including the capability to add to or replace content during the fact of the streaming. Specifically, modification could enable a process similar to the well-known “green screen” backgrounds, but without the actual “green screen” in the recording. In other words, a streaming video could have sections of the background (or foreground) edited out (removed) from the stream, it could have sections embedded with different content, or it could do a combination of approaches, including addition, alteration, or deletion of content in the original video source. More specifically, the real-time manipulation hardware 106 has a hardware structure which has a capacity to perform various manipulations, including embedding shapes and/or text, inserting advertisements, providing user interactions (such as manual drawings or highlighting), user chat areas, provenance labeling of each of the source elements and each of the manipulations, reconstitution of original or manipulated content, social media integration, alternate source image or video inclusion, same source image or video inclusion (e.g., instant replay), and so on. Content manipulation by the real-time manipulation hardware 106 may be performed in the absence of analytics by the real-time analytics hardware 104.

The performed analytics by the real-time analytics hardware 104 and the modified streaming content are presented to streaming hardware 112, the hardware structure of which is suitable for generating the streaming content for broadcasting or recording or for collaboration. The streaming hardware 112 uses a stream reassembly process to reconstruct a single, unified representation of the stream. The reassembled stream is then either passed to a display (e.g., a video display or video recording device, and so on), or to a network interface (e.g., for internet distribution, for remote storage, and so on), or to both.

The system 100 includes real-time collaboration hardware 110A-110C, the hardware structures of which have the capacity to facilitate social interactions resulting in specific types of modifications to the streaming content. For example, a streaming video could allow a person using a Facebook account to log in and interact with the video. Interactions on the video could exist between known parties or unknown parties. Interactions could include drawings or other physical manipulations of the streaming content, or they could be via a chat dialog window overlaid within the streaming content. In the case of an overlaid chat dialog window, the location of the embedded content could adapt, for example, based on the analytics of the streaming content to avoid disrupting any important points of interest in the streaming content.

As another example, the pieces of real-time collaboration hardware 110A-110C facilitate collaboration of video, bringing multiple observers to the same instance of the video. Collaborative Video Exploitation and Manipulation (CVEM) is designed in the system 100 to perform any type of video analytics while multiple users have access to the video. This enables groups to chat, load images, and sketch straight onto the video. Empowering operators with the ability to consult across a video stream reduces time to decision and increases awareness across a consortium. The pieces of real-time collaboration hardware 110A-110C also facilitate cognition along with analytics provided by the real-time analytics hardware 104. This capability, unique to embodiments of CVEM, reduces wasteful time in communication efforts across geographically separated personnel.

Collaborative content from the pieces of real-time collaboration hardware 110A-110C are presented to command controller hardware 108, the hardware structure of which is capable of parsing commands from data and feeding them back to the real-time analytics hardware 104 and the real-time manipulation hardware 106. This feedback loop allows the ongoing inclusion of time-based or trending type analytics. The command controller hardware 108 also takes instruction from a user interface (not shown) and the analytics of the real-time analytics hardware 104 to affect manipulation changes made by the real-time manipulation hardware 106. The command controller hardware 108 is where a programmatic decision to use analytics of the real-time analytics hardware 104 matches a user's intent as expressed through the user interface to modify the streaming content.

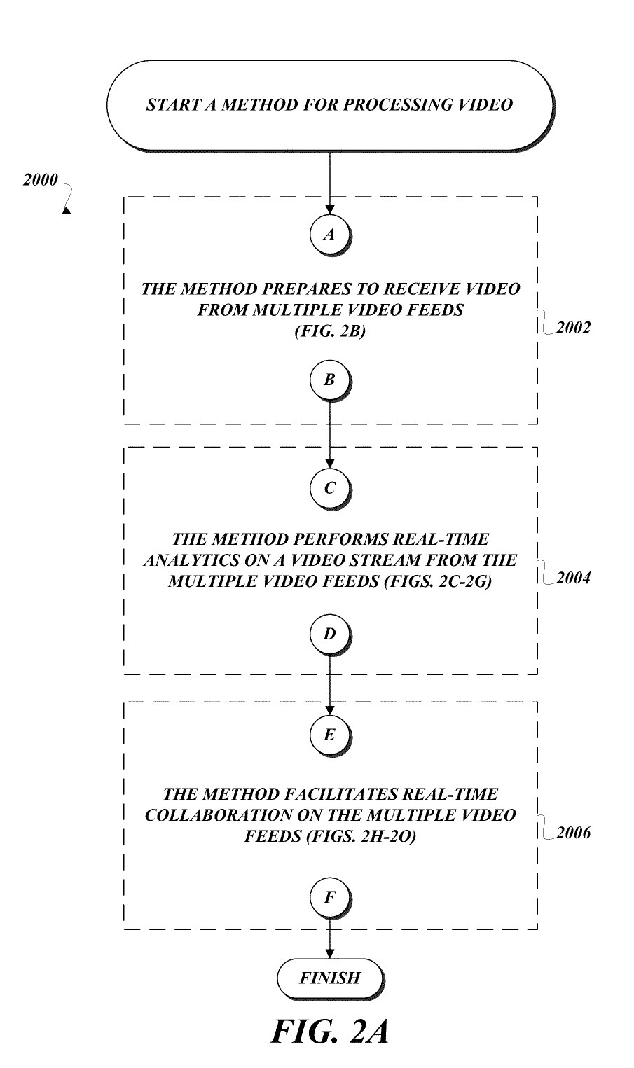

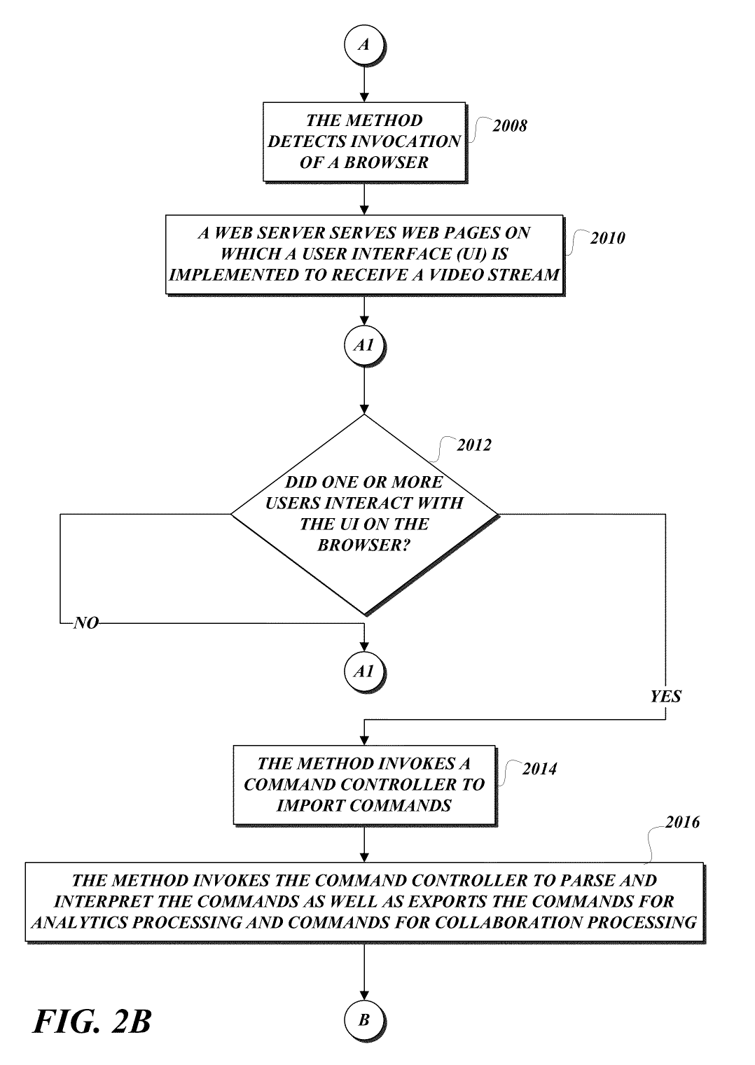

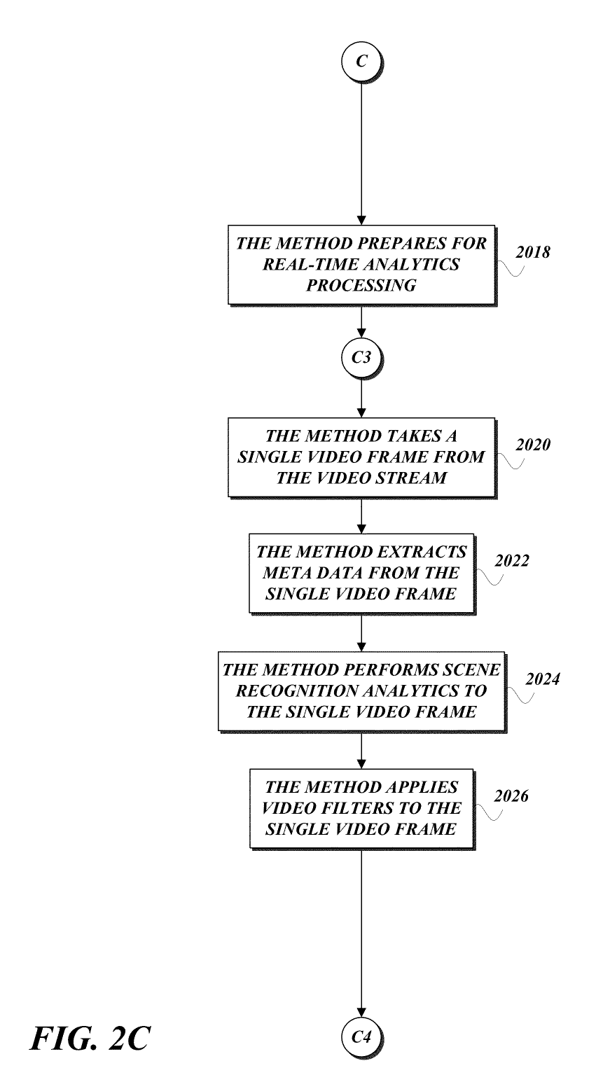

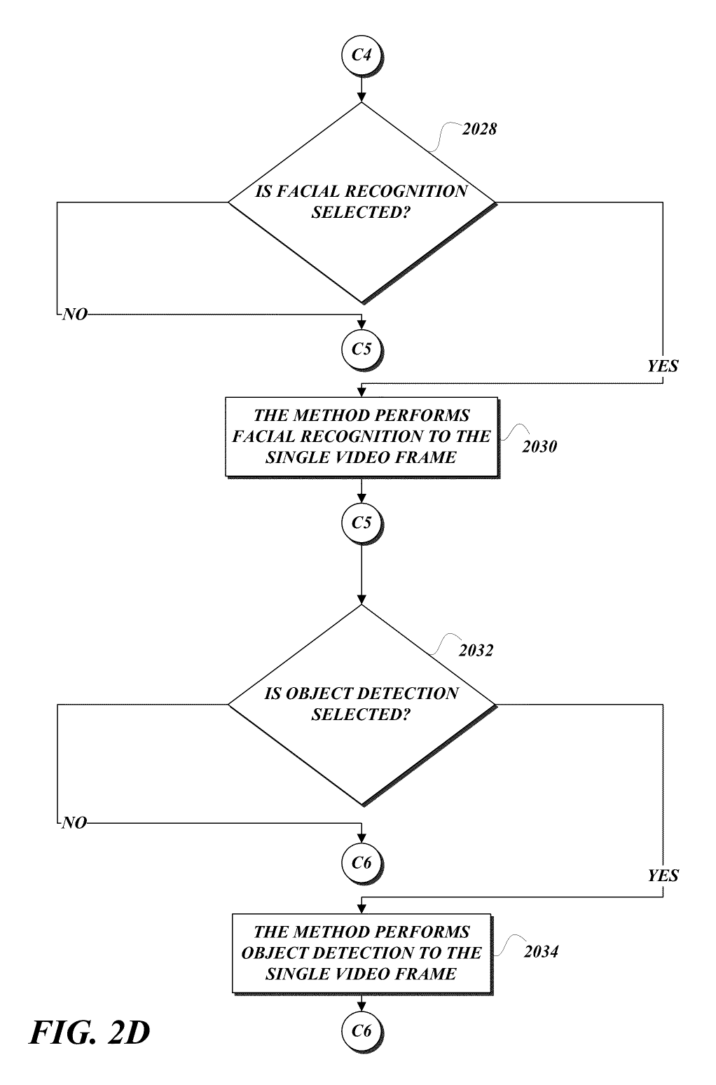

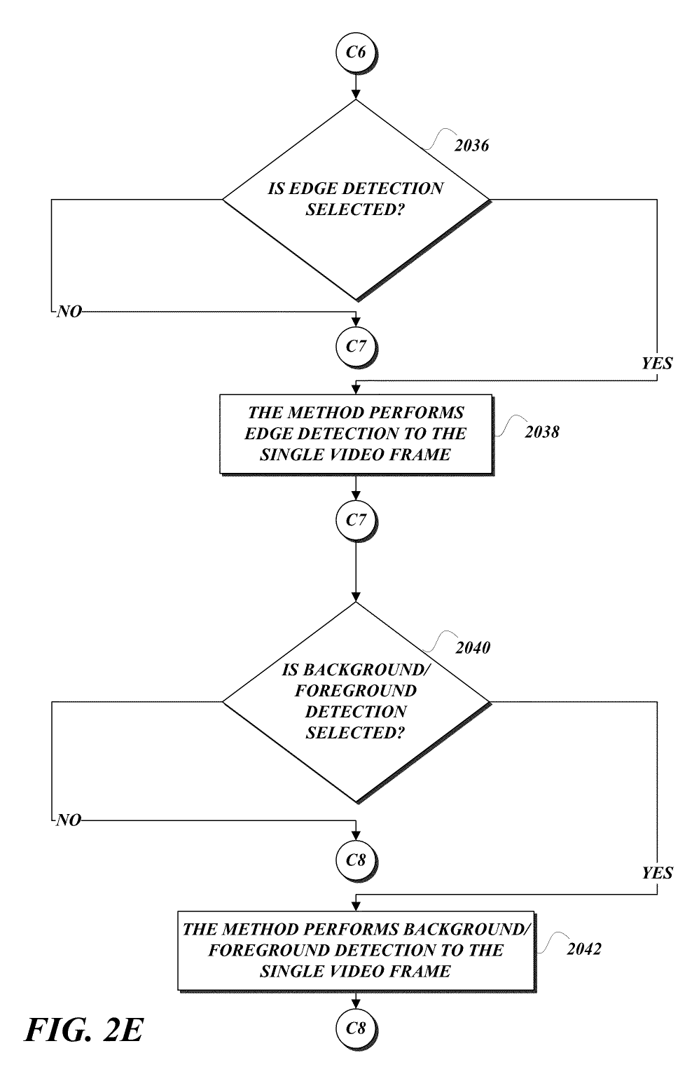

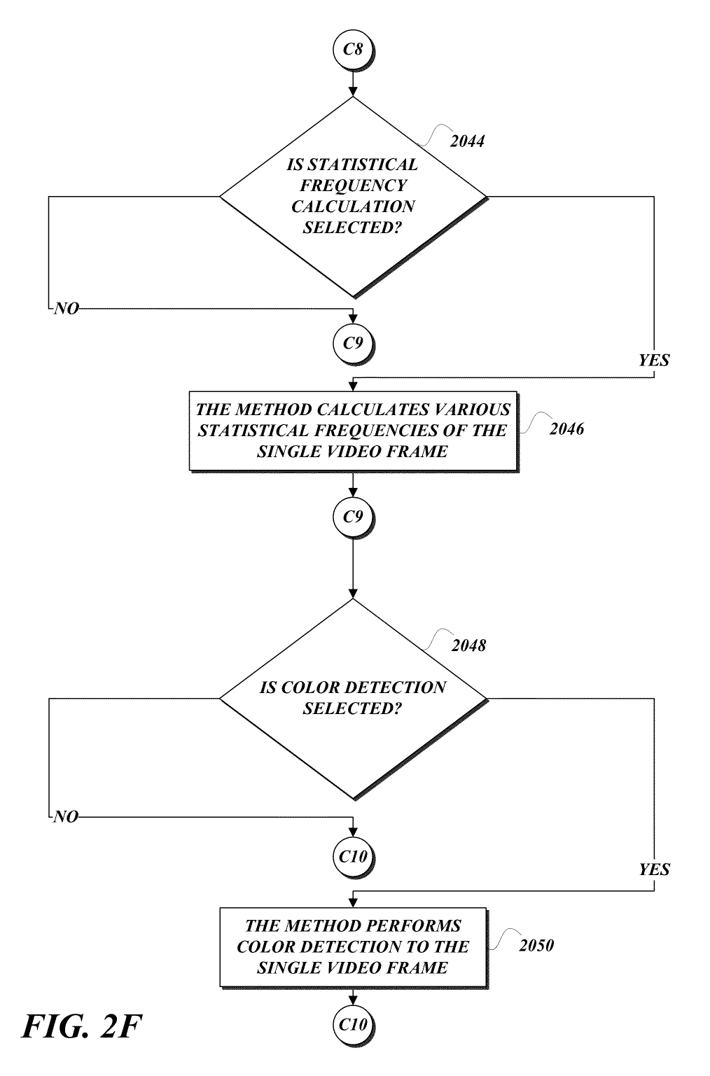

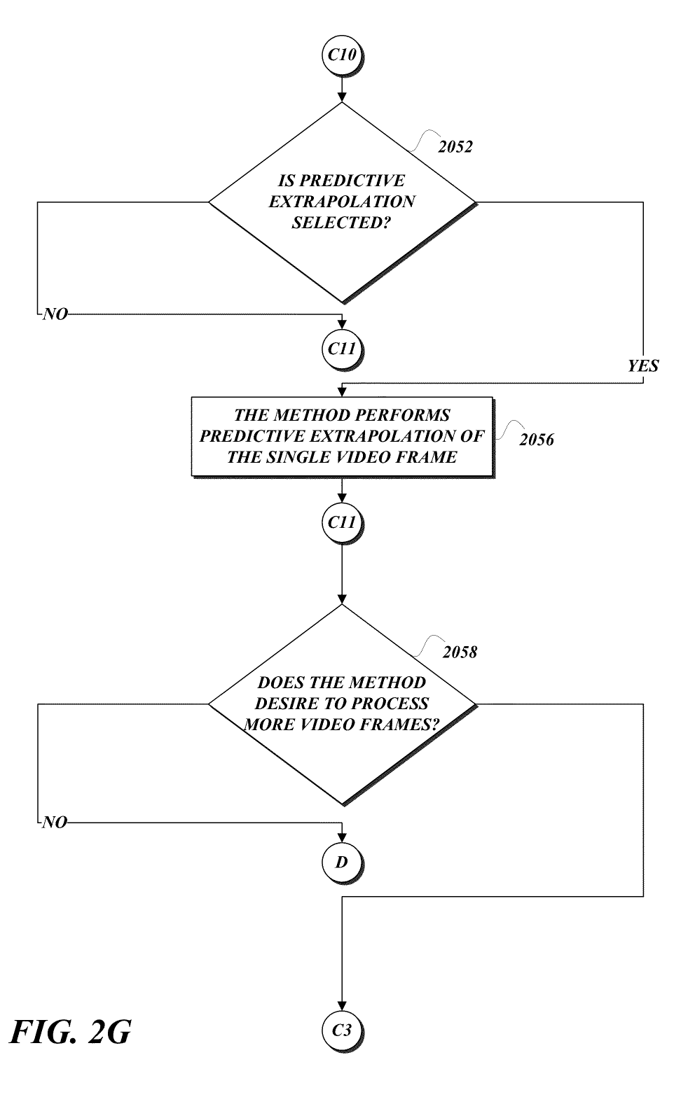

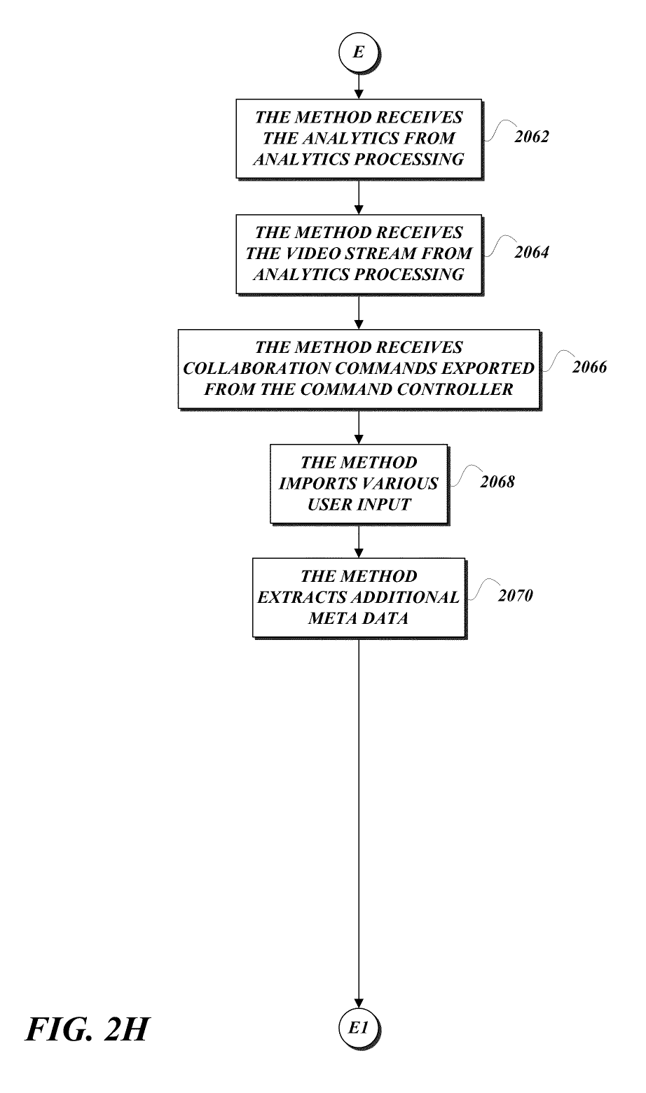

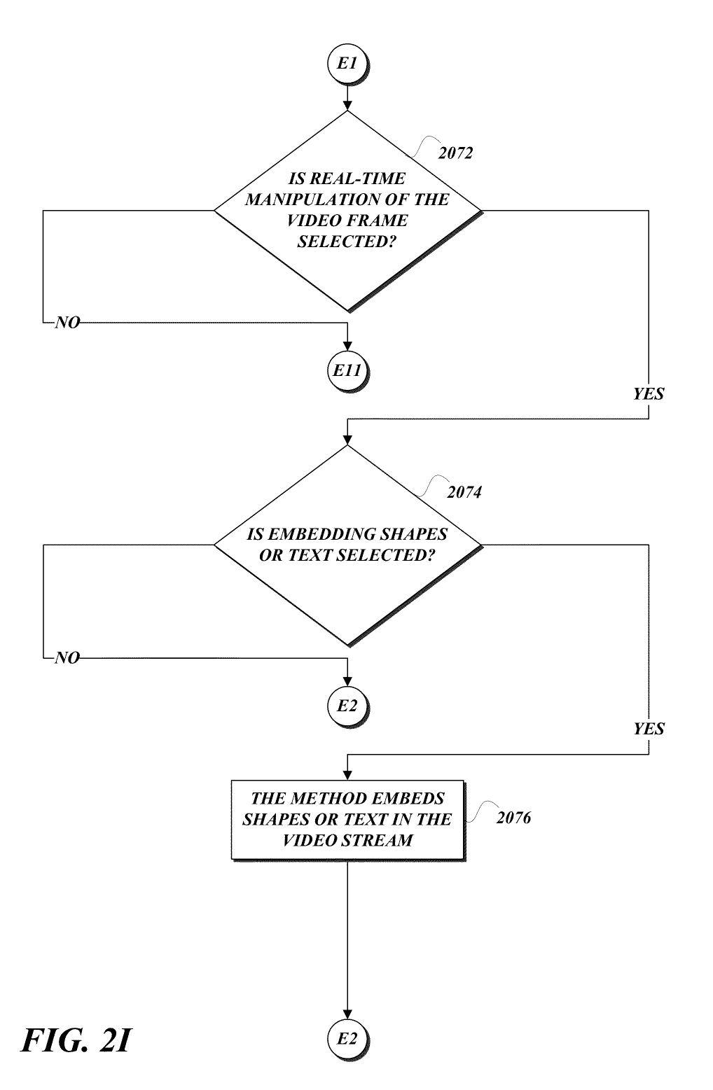

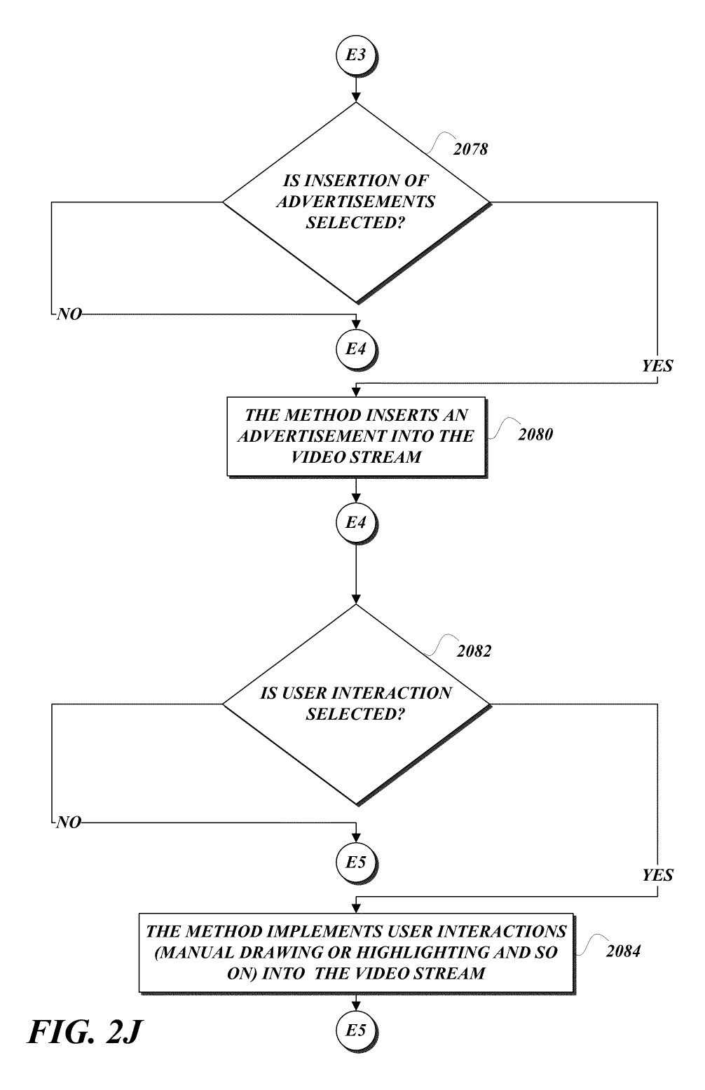

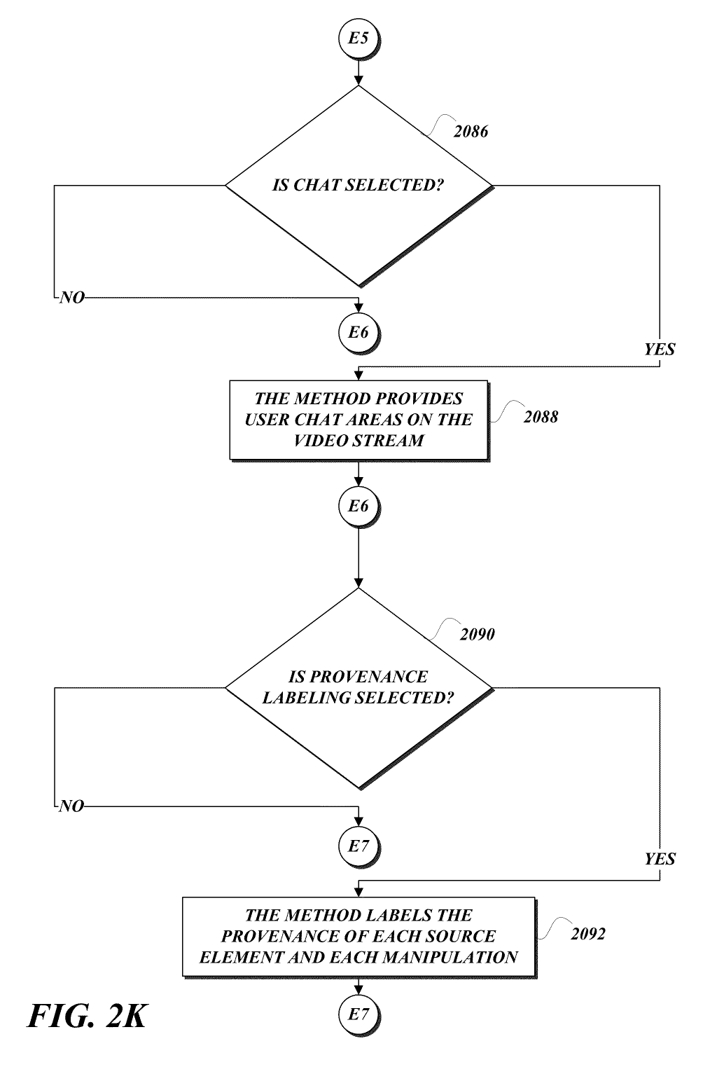

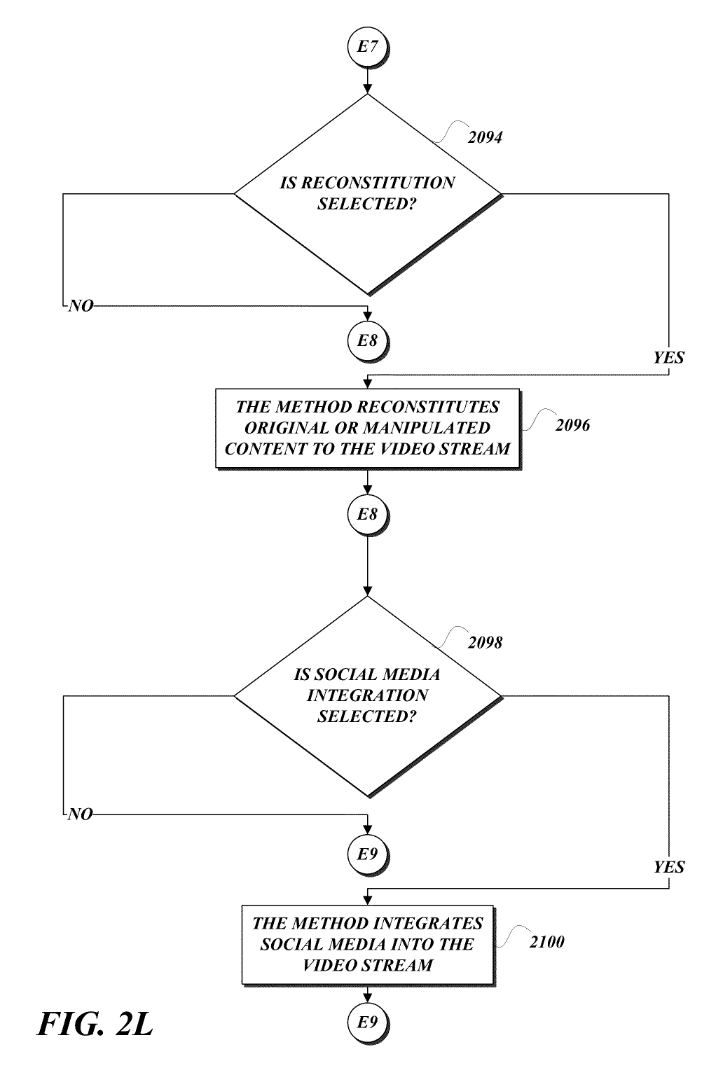

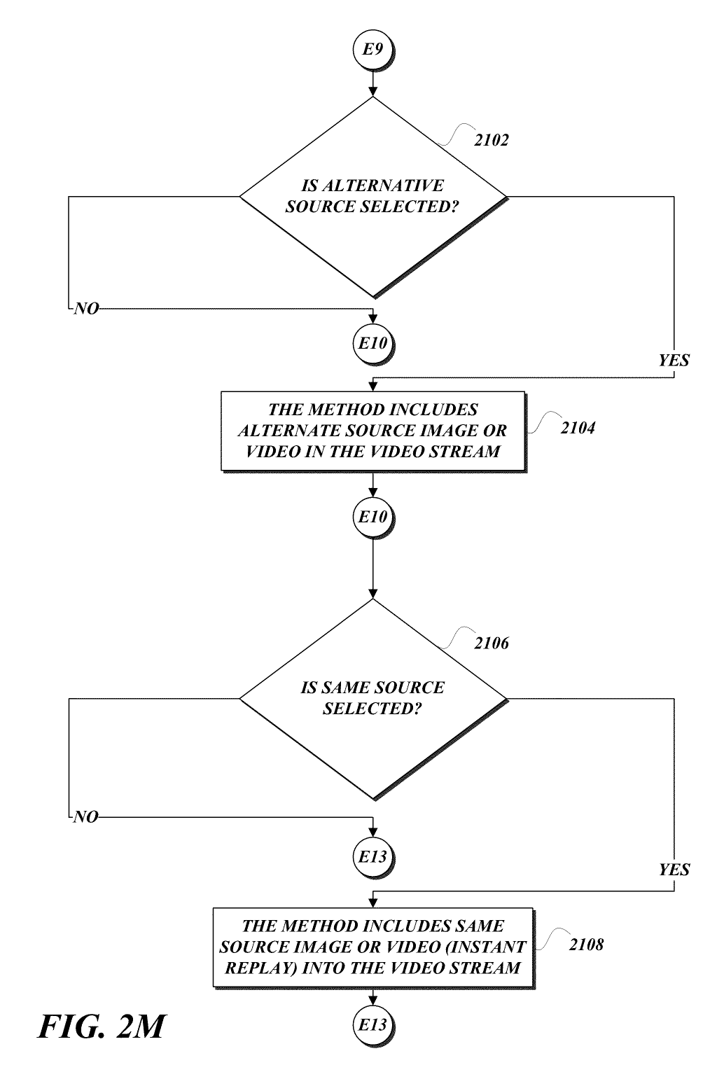

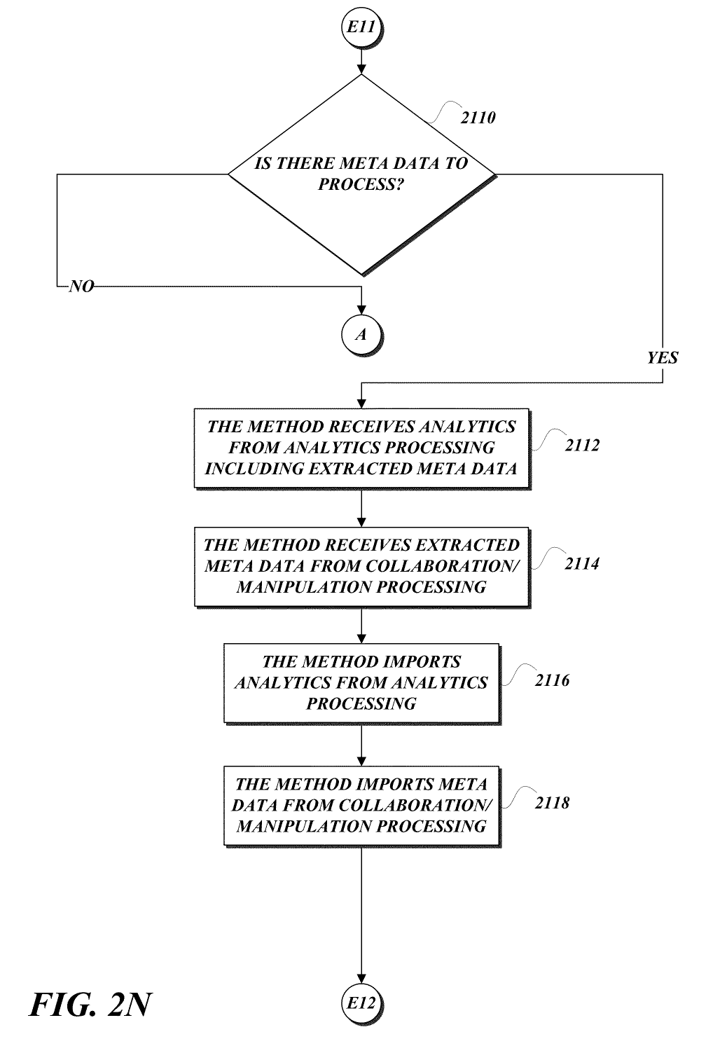

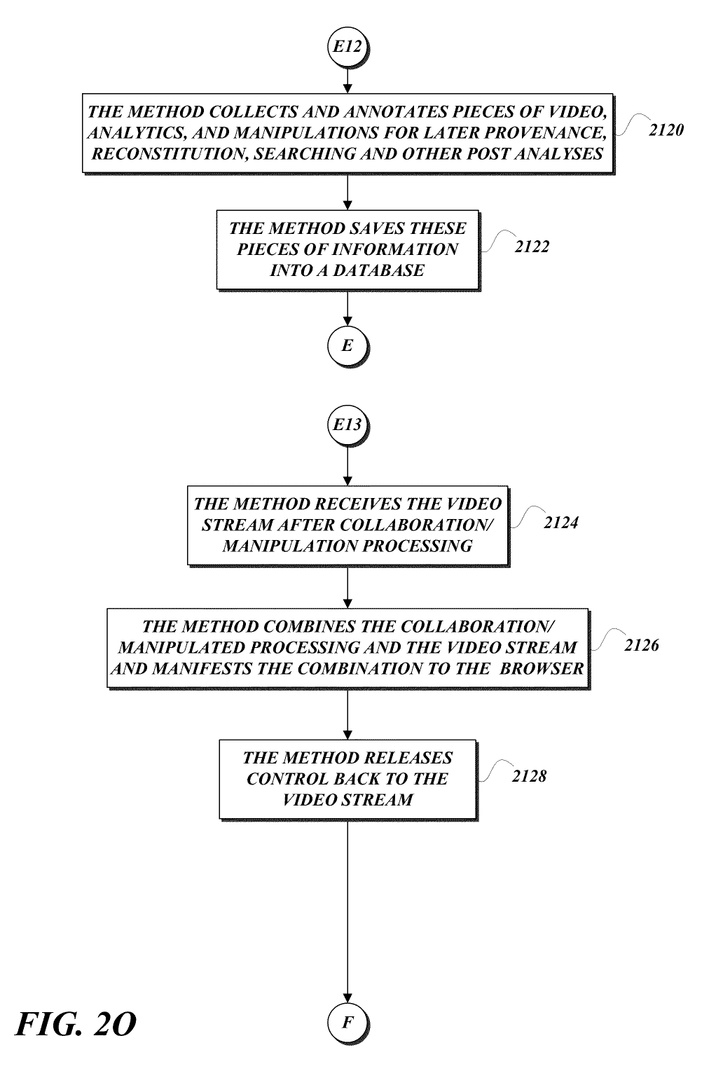

FIGS. 2A-2O are process diagrams implementing an exemplary method 2000 for facilitating video processing. From a start block, the method 2000 proceeds to a set of methods steps 2002 defined between the continuation terminal (“terminal A”) and another continuation terminal (“terminal B”.) The set of method steps 2002 prepares to receive video from multiple video feeds. From terminal A (FIG. 2B), the method 2000 proceeds to block 2008, where the method detects invocation of a browser. At block 2010, a web server serves web pages on which a user interface (UI) is implemented to receive a video stream. The method 2000 then proceeds to another continuation terminal (“terminal A1”.) From terminal A1 (FIG. 2B), the method 2000 proceeds to decision block 2012 where a test is performed to determine whether one or more users interact with the user interface on the browser. If the answer to the test at decision block 2012 is NO, the method proceeds to terminal A1 and skips back to the above-identified processing step. Otherwise, if the answer to the test at decision block 2012 is YES, the method proceeds to block 2014 where the method invokes a command controller to import commands. At block 2016, the method invokes the command controller to parse and interpret the commands, as well as export the commands for analytics processing and commands for collaboration processing. The method then continues to terminal B.

From terminal B, the method 2000 proceeds to a set of method steps 2004 defined between a continuation terminal (“terminal C”) and another continuation terminal (“terminal D”.) The set of method steps 2004 performs real-time analytics on a video stream from the multiple video feeds. From terminal C (FIG. 2C), the method 2000 proceeds to block 2018 where the method prepares for real-time analytics processing. The method then continues to a continuation terminal (“terminal C3”.) From terminal C3 (FIG. 2C), the method proceeds to block 2020 where the method takes a single video frame from the video stream. At block 2022, the method extracts metadata from the single video frame. At block 2024, the method applies scene recognition analytics to the single video frame. At block 2026, the method applies video filters to the single video frame. The method then continues to another continuation terminal (“terminal C4”.)

From terminal C4 (FIG. 2D), the method 2000 proceeds to decision block 2028 where a test is performed to determine whether facial recognition is selected. If the answer to the test at decision block 2028 is NO, the method proceeds to another continuation terminal (“terminal C5”.) Otherwise, if the answer to the test at decision block 2028 is YES, the method proceeds to block 2030 where the method applies facial recognition to the single video frame. The method then continues to terminal C5. From terminal C5 (FIG. 2D), the method proceeds to decision block 2032 where a test is performed to determine whether object detection is selected. If the answer to the test at decision block 2032 is NO, the method proceeds to another continuation terminal (“terminal C6”.) Otherwise, if the answer to the test at decision block 2032 is YES, the method proceeds to block 2034, where the method applies object detection to the single video frame. The method then continues to terminal C6.

From terminal C6 (FIG. 2E), the method proceeds to decision block 2036, where a test is performed to determine whether edge detection is selected. If the answer to the test at decision block 2036 is NO, the method proceeds to another continuation terminal (“terminal C7”.) Otherwise, if the answer to the test at decision block 2036 is YES, the method proceeds to block 2038 where the method applies edge detection to the single video frame. The method then continues to terminal C7. From terminal C7 (FIG. 2E), the method proceeds to decision block 2040 where a test is performed to determine whether background/foreground detection is selected. If the answer to the test at decision block 2040 is NO, the method proceeds to another continuation terminal (“terminal C8”.) Otherwise, if the answer to the test at decision block 2040 is YES, the method proceeds to block 2042 where the method applies background/foreground detection to the single video frame. The method then continues to terminal C8.

From terminal C8 (FIG. 2F), the method proceeds to decision block 2044 where a test is performed to determine whether statistical frequency calculation is selected. If the answer to the test at decision block 2044 is NO, the method proceeds to another continuation terminal (“terminal C9”.) Otherwise, if the answer to the test at decision block 2044 is YES, the method proceeds to block 2046 where the method calculates various statistical frequencies of the single video frame. The method then continues to terminal C9. From terminal C9 (FIG. 2F), the method proceeds to decision block 2048 where a test is performed to determine whether color detection is selected. If the answer to the test at decision block 2048 is NO, the method proceeds to another continuation terminal (“terminal C10”.) Otherwise, if the answer to the test at decision block 2048 is YES, the method proceeds to block 2050 where the method applies color detection to the single video frame. The method then continues to terminal C10.

From terminal C10 (FIG. 2G), the method proceeds to decision block 2052 where a test is performed to determine whether predictive extrapolation is selected. If the answer to the test at decision block 2052 is NO, the method proceeds to another continuation terminal (“terminal C11”.) Otherwise, if the answer to the test at decision block 2052 is YES, the method proceeds to block 2056 where the method performs predictive extrapolation of the single video frame. The method then continues to terminal C11. From terminal C11 (FIG. 2G), the method proceeds to decision block 2058 where a test is performed to determine whether the method desires to process more single video frames. If the answer to the test at decision block 2058 is NO, the method proceeds to terminal D. Otherwise, if the answer to the test at decision block 2058 is YES, the method proceeds to terminal C3, where the above discussed processing steps are repeated. One additional analytics example includes detecting a change in the single video frame. Other analytics examples are possible.

From terminal D (FIG. 2A), the method proceeds to a set of method steps 2006 defined between a continuation terminal (“terminal E”) and another continuation terminal (“terminal F”.) The set of method steps 2006 facilitates real-time collaboration on the multiple video feeds. From terminal E (FIG. 2H), the method proceeds to block 2062 where the method receives the analytics from analytics processing. At block 2064, the method receives the video stream from analytics processing. At block 2066, the method receives collaboration commands exported from the command controller. At block 2068, the method imports various user input. At block 2070, the method extracts additional metadata. The method then continues to another continuation terminal (“terminal E1”.)

From terminal E1 (FIG. 2I), the method proceeds to decision block 2072 where a test is performed to determine whether real-time manipulation of the video frame is selected. If the answer to the test at decision block 2072 is NO, the method proceeds to another continuation terminal (“terminal E11”.) Otherwise, if the answer to the test at decision block 2072 is YES, the method proceeds to decision block 2074 where a test is performed to determine whether embedding shapes or text is selected. If the answer to the test at decision block 2074 is NO, the method proceeds to another continuation terminal (“terminal E2”.) Otherwise, if the answer to the test at decision block 2074 is YES, the method proceeds to block 2076 where the method embeds shapes or text in the video stream. The method then continues to terminal E2.

From terminal E3 (FIG. 2J), the method 2000 proceeds to decision block 2078 where a test is performed to determine whether insertion of an advertisement is selected. If the answer to the test at decision block 2078 is NO, the method proceeds to another continuation terminal (“terminal E4”.) Otherwise, if the answer to the test at decision block 2078 is YES, the method proceeds to block 2080 where the method inserts an advertisement into the video stream. The method then continues to terminal E4. From terminal E4 (FIG. 2J), the method proceeds to decision block 2082 where a test is performed to determine whether user interaction is selected. If the answer to the test at decision block 2082 is NO, the method proceeds to another continuation terminal (“terminal E5”.) Otherwise, if the answer to the test at decision block 2082 is YES, the method proceeds to block 2084 where the method implements user interactions (manual drawing or highlighting and so on) into the video stream. The method then continues to terminal E5.

From terminal E5 (FIG. 2K), the method 2000 proceeds to decision block 2086 where a test is performed to determine whether chat is selected. If the answer to the test at decision block 2086 is NO, the method proceeds to another continuation terminal (“terminal E6”.) Otherwise, if the answer to the test at decision block 2086 is YES, the method proceeds to block 2088 where the method provides user chat areas on the video stream. The method then continues to terminal E6. From terminal E6 (FIG. 2K), the method proceeds to decision block 2090 where a test is performed to determine whether provenance labeling is selected. If the answer to the test at decision block 2090 is NO, the method proceeds to another continuation terminal (“terminal E7”.) Otherwise, if the answer to the test at decision block 2090 is YES, the method proceeds to block 2092 where the method labels the provenance of each source element and each manipulation. The method then continues to terminal E7.

From terminal E7 (FIG. 2L), the method proceeds to decision block 2094 where a test is performed to determine whether reconstitution is selected. If the answer to the test at decision block 2094 is NO, the method proceeds to another continuation terminal (“terminal E8”.) Otherwise, if the answer to the test at decision block 2094 is YES, the method proceeds to block 2096 where the method reconstitutes original or manipulated content to the video stream. The method then continues to terminal E8. From terminal E8 (FIG. 2L), the method proceeds to decision block 2098, where a test is performed to determine whether social media integration is selected. If the answer to the test at decision block 2098 is NO, the method proceeds to another continuation terminal (“terminal E9”.) Otherwise, if the answer to the test at decision block 2098 is YES, the method proceeds to block 2100 where the method integrates social media into the video stream. The method then continues to terminal E9.

From terminal E9 (FIG. 2M), the method proceeds to decision block 2102 where a test is performed to determine whether an alternative source is selected. If the answer to the test at decision block 2102 is NO, the method proceeds to another continuation terminal (“terminal E10”.) Otherwise, if the answer to the test at decision block 2102 is YES, the method proceeds to block 2104 where the method includes an alternative source image or video in the video stream. The method then continues to terminal E10. From terminal E10 (FIG. 2M), the method proceeds to decision block 2106 where a test is performed to determine whether same source is selected. If the answer to the test at decision block 2106 is NO, the method proceeds to another continuation terminal (“terminal E13”.) Otherwise, if the answer to the test at decision block 2106 is YES, the method proceeds to block 2108 where the method includes same source image or video (such as instant replay) in the video stream. The method then continues to terminal E13.

From terminal E11 (FIG. 2N), the method 2000 proceeds to decision block 2110 where a test is performed to determine whether there are metadata to process. If the answer to the test at decision block 2110 is NO, the method proceeds to terminal A and skips back to previously discussed processing steps. Otherwise, if the answer to the test at decision block 2110 is YES, the method proceeds to block 2112 where the method receives analytics from analytics processing, including extracted metadata. At block 2114, the method receives extracted metadata from collaboration/manipulation processing. At block 2116, the method imports analytics from analytics processing. At block 2118, the method imports metadata from collaboration/manipulation processing. The method then continues to another continuation terminal (“terminal E12”.)

From terminal E12 (FIG. 2O), the method proceeds to decision block 2120 where the method collects and annotates pieces of video, analytics, and manipulations for later provenance, reconstitution, searching, and other post-analysis. The method then continues to block 2122 where the method saves these pieces of information into a database. The database is used as an additional output channel for the stream video to allow for subsequent activities on the real-time manipulations. It could be used for identifying which portions of the video were manipulated, who manipulated the portions, and what was the underlying set of attributes (analytics) which led to that manipulation. The database is not necessary for the real-time analytics and manipulation, but allows for additional robustness of the system 100. The method then continues to terminal E and skips back to previously-discussed processing steps. From terminal E13 (FIG. 2O), the method proceeds to block 2124 where the method receives the video stream after collaboration/manipulation processing. At block 2126, the method combines the collaboration/manipulated processing and the video stream and manifests the combination to the browser. At block 2128, the method releases control back to the video stream. The method then terminates execution.

Hereinbelow, examples are provided which are not intended to be an exhaustive list of each possible operation of the system 100 and the method 2000 described hereinabove.

The first example is directed to embedding advertising. Televised sporting events are lucrative opportunities for advertisers. Commercial advertising breaks have been a common occurrence since the beginning of televised events. Since advertisers recognize that these breaks provide the opportunity for viewers to leave the room, they have long sought alternatives that are more embedded within the actual sporting event. Advertisements are displayed around the sporting facility, for example, and are incidentally included during the filming of the event. In addition, individual players or teams are commonly sponsored by a company and may include visible advertising on their persons. However, many of these methods have a low salience for viewers depending on the camera angle or other players obscuring the advertisements.

Nike has recognized these issues and has worked with ESPN to install the system 100 during their televised basketball events. With the analytic capability occurring in real time during the basketball event, the system 100 is able to perform object recognition of the basketball and generate a heat map (another analytics computation) of the areas where the basketball is spending the most time on the court. Nike then pays ESPN for an advertising spot to place the Nike logo on the court where the ball is most likely to occur, and during the next camera close-up of that area the real-time manipulation hardware 106 inserts an advertisement to appear as if it were part of the basketball court, without obscuring the basketball players or the basketball.

Further, since the method 2000 occurs in real-time during the original event stream, all subsequent “instant replays” during the event and all game highlights played at later review periods, such as the nightly sports news, include the original Nike dynamic advertisements since that advertisement was part of the original recorded live video. Nike is pleased with this new advertising capability and discovers they are able to use it to place advertisements on the basketball backboard during free throws, and many other times throughout the game to dynamically optimize their advertisement views and therefore receive a better return on their advertising dollar. ESPN sees how Nike has identified an excellent new advertising revenue opportunity and begins using the real-time analytics hardware 104 to help them identify a pricing structure based on advertisement placement prominence, frequency, and duration, as well as on other key events within the basketball game, such as during high action periods or close team scores.

The second example is directed to embedding social interactions. Big Dave's Security is the leading security firm in the area. They monitor museums, warehouses, businesses, and other locations with millions of dollars of value. Part of Big Dave's ability to provide effective security includes video monitoring of important sites in addition to their other more traditional security approaches, including alarm systems and patrols. With video monitoring, Big Dave's can provide better coverage of more areas than other security firms, but only if they are able to keep their staffing costs in check. Live monitoring is very personnel intensive and requires a high level of alertness by those viewing the video feed.

Big Dave's has discovered that they can use the system 100 to help them focus on the “suspect” video feeds and pay less attention to the “normal” video feeds. Using the real-time analytics hardware 104, they are able to incorporate facial recognition to ignore the video containing their security patrols, use background/foreground detection to identify unusual activity, and also use methods to identify change in the video image. The system 100 is configured to recognize the various camera angles and view coverage to provide a continuity of analytics across several cameras 102A-102D. This combination of automated monitoring allows the video monitoring system to provide alerts and focus on the important video feeds while placing the irrelevant feeds in the background of the security monitor's tasks.

Continuing with the second example, Sam is a new hire at Big Dave's Security. Sam has gone through the video monitoring training, but is still not one of the more experienced monitoring staff at Big Dave's Security. One evening while monitoring the video feeds for a local computer business, Sam is notified by the system 100 that there is unusual activity detected on one of the camera feeds 102A-102D. Sam reviews the live camera feed from the system 100, with the real-time manipulation hardware 106 providing the suspect area in high contrast. Sam looks at the video feed and he thinks it looks like the shadow of a building or vehicle. However, he is not sure so he contacts his supervisor via the real-time collaboration hardware 110A-110C of the system 100. Sam's supervisor Sally has 15 years of experience monitoring security feeds and works at a different office location from Sam. Sally remotely joins Sam while viewing the video feed. During the real-time collaboration, Sally is able to chat with Sam in a chat window provided by the real-time collaboration hardware 110A-110C overlaid within the security footage in an unimportant area of the video feed. Sam and Sally now see the same image that the system 100 has provided in high contrast to indicate the suspect area. Sam chats to Sally that he thinks it looks like a shadow, but he is unsure. Sally is able to watch the video and notices a bit of movement indicating why this may not be a shadow. She uses her ability to interact with the system 100's video feeds to select, highlight, and indicate with some drawings that the shadow with unusual movement is actually a person dressed in black and keeping near the buildings and vehicles. Sam notifies the nearest Big Dave's Security patrol to quickly check out the unusual activity in person and secure the business.

Because Big Dave's Security uses the system 100 to help monitor their client's sites, they are able to quickly identify a potential threat to a client, even with an inexperienced employee monitoring the video feeds. The inexperienced employee would have missed this subtle problem, but instead was notified of the issue by the system 100. Since the novice employee still did not recognize the problem in the video, he was able to communicate with a more experienced person who was able to verify the problem and use the system 100 to provide training to the new employee, making him more effective the next time this happens. Big Dave's Security usage of the system 100 allows them to discover the problem quickly, and efficiently, and to subsequently increase the loyalty of their client.

The third example is directed to embedding video. Due to the original success of embedding advertising into live basketball games, ESPN decides to expand its use of the system 100. They notice that the real-time analytics hardware 104 performs combined analytics in which object detection is performed with predictive extrapolation. ESPN suspects this combination can be used to identify important and unlikely sporting outcomes shortly before they happen. For instance, ESPN believes that they may be able to identify the winning horse in a horse race before the horse finishes the race. They package this capability and offer it to advertisers.

Several sponsors opt to use the new advertising capability, and one advertiser, Maker's Mark Whiskey, decides to try something unusual. They buy an advertisement to place on the winning horse as it crosses the finish line. However, rather than placing a static image advertisement on the horse (as Nike had done on the floor of the basketball court), Maker's Mark has a video of their whiskey being poured and a subsequent toast to a winner of a horse race. The real-time manipulation hardware 106 facilitates insertion of a video and places the video advertisement directly on the large flank of the winning horse just as it crosses the finish line. Because of the analytics provided by the real-time analytics hardware 104, the video is overlaid by the real-time manipulation hardware 106 exactly on the horse even as the shape of the running horse fluctuates. The horse provides an excellent “screen” for the embedded video to play and the advertisement works well for Maker's Mark to introduce its brand to a larger audience. Based on this success, ESPN adds the predictive capabilities to other sporting events, starting with golf where they can use the prediction capability to identify good shots as they happen and provide the advertising space on the green as the golf ball nears the cup. Several advertisers take advantage of the predictive shot capability in golf and use it to display still and video ads at the most opportune moments.

The fourth example is directed to special effects in movies and live TV. Hollywood TV and movie producer RealityTV sees how ESPN has used the system 100 to insert advertising and recognizes how they could use the same technology for on-the-fly effects in their movies and TV sets. Specifically, they have had trouble with boom microphones occasionally entering the shot while filming their latest reality TV series. Using the real-time analytics hardware 104 they are able to detect when the microphone is accidentally visible and then edit out the microphone using the real-time manipulation hardware 106 without any of the TV audience observing it.

The ability to remove the microphone makes RealityTV producers realize that they have an opportunity to do even more, and they begin adding special effects into their live broadcasts. They start with changing the colors of objects, such as chairs and tables, and move on to more ridiculous effects, such as shooting beams of color from actors' fingers and changing the scenes occurring in the background or via windows on the set. As they start making the unusual live effects, they notice an increase in their viewing audience and they then play to this audience interest. The RealityTV producers begin using the ability inherent in the system 100 to interact with social media and allow their viewers to have an ongoing dialog during live broadcasts. Based on the current events in the broadcast, RealityTV is able to push out polls to their viewers, and based on the poll results, provide unusual effects into the streaming video. RealityTV becomes so proficient with the use of capabilities of the system 100 for real-time addition of special effects through their TV broadcasts, they discover that they could use this capability for longer format broadcasts such as concerts and also eliminate much of the post-processing steps in their direct to video movies.

The fifth example is directed to augmented reality. Augmented reality is the overlay of virtual information onto elements in the real world. It is well known and established in the art across many applications. More modern systems are developed all the time, with the most recent highly publicized system by Google called Google Glass intended for individuals to interact with virtual entities via their glasses. Integrating the system 100 with an augmented reality system allows for the incorporation of a variety of real-time analytics to manipulate the displayed image to the wearer. While all augmented reality systems have the capability to overlay information, their interactive and manipulative capabilities are limited. With the combination of facial recognition, for instance, the system 100 can manipulate the specific recognized individuals with different images or video. Advertising can be displayed based on individual observations. Predictive motion can be highlighted to eliminate accidents or to indicate interesting areas to view.

The sixth example is embedding disparate sensor data. FocalSecurity buys the system 100 to enable the social media aspect of the system. FocalSecurity also sees the success ESPN has had with using the system 100 for embedding images into the video stream. They decide that they want to inject other sensor types of data into the video as well. FocalSecurity applies Global Positioning System (GPS) output as a component of the video feed. Since FocalSecurity knows where all of their fleet operators and personnel are traveling, they can quickly identify all of their fleet vehicles in all traffic cameras as well as all personnel around their buildings.

During one of FocalSecurity's foot patrols, the police scanner announces the presence of suspected armed burglars in the vicinity of the FocalSecurity guard. The nearest video camera on the building does not have a lighted view of the area so there is no discernible recognition of any individuals. FocalSecurity's home station can see a dot blipping in the video because of the ability of the system 100 to insert the GPS location of the guard. FocalSecurity's home station notices that there is movement in a location where the guard cannot see. An immediate radio message is delivered to the FocalSecurity roving guard warning of a potential threat. FocalSecurity's guard approaches with caution and is able to quickly apprehend the perpetrators. Due to FocalSecurity's use of the system 100's embedding technology, FocalSecurity was able to accurately track and monitor an otherwise indiscernible person using a GPS signal as the indication of their own security guard's location. The FocalSecurity home station was able to deliver real-time updates to the guard and ultimately apprehend armed perpetrators. This is good for FocalSecurity because in the high crime area where they patrol they have lost many guards to armed confrontation.

The seventh example is directed to synthesizing analysis across a wide array of inputs. The local police get news of the success of FocalSecurity using the system 100 and decide they will do the same. They can now accurately track all vehicles within the various traffic and security cameras placed around the city. They begin to test and play with the type of real-time analytics that can address many situations and realize they can use geo-located Twitter feeds that are quickly addressed for negative sentiment about the police right into the video stream.

The local police decide to use this capability to help understand the public sentiment around their officers. During this time they realize many things, such as a Twitter user's displeasure at the appearance of a police officer. The police can see the last known geo-coordinates of the Twitter user within the video. In other places they see positive geo-located sentiment feeds pop up and understand where those individuals are located in proximity to the officer. During one of the officer's patrols, headquarters notices a relatively large cluster of extremely negative sentiment converging near the officer. The entire thing is visible on video so the headquarters personnel are able to see a crowd start to form while the patrol officer remains completely unaware. Since the geo-location of the Twitter feeds indicates a mass, headquarters is able to not only warn the patrol officer but immediately call for backup. Using the capability of the system 100 to track and monitor the GPS feeds of the police force, headquarters can now track every police cruiser through every traffic camera and position them according to where they will provide the most help. The officer who is in the hot-spot of activity is being continually monitored within the video as help arrives to disperse the growing crowd. Using the system 100 to track seemingly unrelated geo-referenced Tweets and represent both positive and negative sentiment within a video feed, as well as facial detection, headquarters is also able to identify that suspected terrorists were among those in the crowd causing the disruption and agitating the public.

Because one analyst cannot monitor the entire situation, more analysts are assigned to assist. One camera in particular has the best view of the entire activity as it is forming. Analysts begin to collaborate within the different cameras to enhance their view of the activity. The system 100 is set to track the suspected terrorists within all video cameras available at the location and the police on the ground are able to be directed to the suspects in a safe and controlled manner. Analysts continually chat back and forth within the video, further collecting evidence of the suspected terrorists. In concert, other analysts are able to do disparate video analytics to determine if the suspects are armed or have anything that could be an explosive. This is all captured via analyst comments as well as analysts calling out indiscriminate items using a drawing pallet built into the system 100. The system 100 has helped keep a likely riot under control while simultaneously tracking cruisers, police officers, and suspected terrorists. The system 100 provides police with not only analyzed video, but also the ability to quickly retrieve snap-shots of the suspects in action to determine any illicit behavior, confirm identity, and deliver in-the-moment pictures to police on station within a fraction of time.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system comprising:
multiple video feeds, the hardware structures of which are suitable for sourcing streaming content;
pieces of real-time processing hardware, the hardware structures of which are capable of processing streaming content during a streaming process and not as a post-processing step on stored data; and
pieces of real-time collaboration hardware, the hardware structures of which have the capacity to facilitate social interactions resulting in modifications to the streaming content.

2. The system of claim 1, wherein the pieces of real-time processing hardware include real-time analytics hardware, the hardware structure of which is capable of performing analytics on the multiple video feeds to find meaningful patterns from which knowledge about the streaming content is formed.

3. The system of claim 2, wherein the pieces of real-time processing hardware include real-time manipulation hardware, the hardware structure of which is suitable for facilitating modification of the streaming content including the capability to add to or replace content.

4. The system of claim 3, further comprising command controller hardware, the hardware structure of which is capable of parsing commands from data and feeding them back to the real-time analytics hardware and the real-time manipulation hardware.

5. The system of claim 4, further comprising streaming hardware, the hardware structure of which is suitable for generating the streaming content for broadcasting or recording or for collaboration.

6. A method comprising:
receiving multiple video feeds in the form of streaming content;
real-time processing of streaming content during a streaming process and not as a post-processing step on stored data; and
facilitating real-time social collaborations resulting in modifications to the streaming content.

7. The method of claim 6, wherein real-time processing includes performing real-time analytics on the streaming content selected from a group consisting essentially of facial recognition, object detection, edge detection, background detection, foreground detection, statistical frequency calculation, color detection, predictive extrapolation, and video frame change.

8. The method of claim 7, wherein real-time processing includes performing real-time manipulation on the streaming content selected from a group consisting essentially of embedding shapes, embedding text, insertion of an advertisement, user interaction, chat, provenance labeling, reconstitution, social media integration, security analysis, live special effects, alternative source selection, and same source selection.

9. The method of claim 8, wherein real-time processing includes performing real-time analytics on the streaming content to determine patterns in the streaming content and use the patterns to perform real-time manipulation by altering the streaming content as it occurs.

10. The method of claim 7, wherein performing real-time analytics includes representing pixels in the streaming content as a digital elevation model which is displayed in a continuous three-dimensional model of one of the multiple video feeds involving no storage to pre-process the streaming content.

11. The method of claim 9, wherein facilitating real-time social collaborations is selected from a group consisting essentially of logging into a social network web site to interact with the streaming content, interacting on the streaming content between known parties or unknown parties, drawing on the streaming content, locating embedded content to avoid disrupting a chat dialog window in the streaming content, and bringing multiple observers to a same instance of the streaming content.

12. The method of claim 8, providing a feedback loop to couple real-time social collaborations with performing real-time analytics and performing real-time manipulation to facilitate ongoing inclusion of time-based analytics or trending analytics.

13. The method of claim 8, further comprising performing real-time analytics to object-recognize a basketball, generating a heat map of areas where the basketball is spending most of its time on a court, and performing real-time manipulation by embedding an advertisement on the court where the basketball is likely to occur without obscuring basketball players or the basketball.

14. The method of claim 8, further comprising performing real-time analytics to facially recognize security patrols and ignore a video feed containing security patrols and perform background detection, foreground detection, and change in a video frame to identify suspect video feeds, as well as facilitate real-time social collaborations to review the suspect video feeds.

15. The method of claim 8, further comprising performing real-time analytics to object-recognize together with predictive extrapolation to identify a sports subject that is likely to win, and performing real-time manipulation to place an advertisement video instead of an advertisement image proximate to the sports subject that is likely to win.

16. The method of claim 8, further comprising performing real-time analytics to object-recognize a boom microphone while filming video contents and performing real-time manipulation to remove the boom microphone.

17. The method of claim 8, further comprising performing real-time analytics for an augmented reality system to facially recognize people.

18. The method of claim 8, further comprising performing real-time manipulation to add the GPS location of a guard and performing real-time analytics to identify movement in a location near the GPS location of the guard.

19. The method of claim 8, further comprising performing real-time analytics on a microblogging service to educe negative public sentiment within proximity to police officers in the streaming content.

20. A computer-readable medium, which is non-transitory, having computer-executable instructions stored thereon to implement a method, comprising:
receiving multiple video feeds in the form of streaming content;
real-time processing streaming content during a streaming process and not as a post-processing step on stored data; and
facilitating real-time social collaborations resulting in modifications to the streaming content.
